(19) United States
(12) Patent Application Publication
(10) Pub. No.: US 2018/0215259 A1
(43) Pub. Date: Aug. 2, 2018

(54) SYSTEM FOR ACTUATING A CLUTCH

(71) Applicant: GKN Automotive Ltd., Redditch, Worcestershire (GB)

(72) Inventor: Reinhard Möhlmann, Bergisch Gladbach (DE)

(21) Appl. No.: 15/748,656

(22) PCT Filed: Aug. 19, 2015
(86) PCT No.: PCT/EP2015/069021

§ 371 Date: Jan. 30, 2018

(51) Int. Cl. B60K 23/08; F16D 11/10

(52) U.S. Cl. CPC B60K 23/08; F16D 2011/006; F16D 11/10

(57) ABSTRACT

In a drive train for a motor vehicle, which has a permanently driven primary drive train and a secondary drive train which can be connected to the primary drive train when necessary or decoupled therefrom, in order to couple or decouple from the primary drive train, there is provision for actuating a clutch apparatus of a device for power transmission and/or power distribution, in which the disengagement unit when providing the clutch actuation force which is required for the actuation of the clutch apparatus is operationally connected to secondary drive members or in which there is provided a drive clutch which, in order to provide the clutch actuation force required for the actuation of the clutch apparatus, is capable of producing an operational connection between the primary drive members or the secondary drive members and a manipulated variable unit of the disengagement unit.

### CROSS-REFERENCE TO RELATED APPLICATIONS

This application is a national stage of, and claims priority to, Patent Cooperation Treaty Application No. PCT/EP2015/069021, filed on Aug. 19, 2015, which application is hereby incorporated herein by reference in its entirety.

### BACKGROUND

In recent times, vehicle manufacturers and suppliers have increasingly developed drive train concepts with switchable all-wheel drive. Such drive train concepts have a primary drive train via which the permanently driven primary shaft and the primary drive wheels which are connected thereto are driven and a connectable secondary drive train which comprises a secondary axle with secondary drive wheels and which if necessary can be connected to the primary drive train (engagement operation or “connect” operation) or can be decoupled therefrom (disengagement operation or “disconnect” operation).

When the secondary drive train is connected, the drive power which is provided by the drive unit of the motor vehicle is distributed by means of devices for power transmission and/or power distribution, for example, by means of a PTU (Power Takeoff Unit) and an RDU (Rear Drive Unit), both over the primary drive wheels and over the secondary drive wheels (operation of the vehicle in 4-WD mode or “Connect” mode). When the secondary drive train is decoupled from the primary drive train, however, only the primary drive wheels are driven (operation of the vehicle in 2-WD mode or “disconnect” mode). The secondary drive wheels roll when travelling on the road without contributing to the propulsion.

In such drive trains, it is desirable to decouple the components of the secondary drive train in 2-WD mode as extensively as possible both from the primary axle and from the secondary drive wheels which are rolling on the road during travel so that during this type of operation as many components of the secondary drive train as possible are towed by neither the primary drive train nor by the secondary drive wheels. The power loss brought about by the secondary drive members is thus minimized to a great extent. The components which are stopped in 2-WD mode are in the context of this application referred to as secondary drive members, whereas the permanently rotating components of the overall drive train including the components which rotate with the secondary drive wheels which are rolling on the road are referred to as primary drive members.

Such drive train concepts therefore require, on the one hand, a clutch apparatus which serves to couple secondary drive train components to the permanently driven primary drive train or to decouple it therefrom (interface with the primary drive train). On the other hand, there is intended to be provided a clutch apparatus which connects the secondary drive train components to the secondary drive wheels or the components of the secondary drive train which are also towed by the secondary drive wheels by rolling on the road or separates from them again (interface with the secondary drive wheel). Only when such clutch apparatuses are provided can a portion of the secondary drive train, that is to say, the portion located between the two clutch apparatuses or interfaces, be completely stopped, since during travel it is driven or towed neither by the permanent primary drive train nor by the secondary drive wheels which are travelling on the road during travel.

There are associated with the clutches systems for clutch actuation which carry out the actual clutch operation, that is to say, in particular the engagement or disengagement of the clutch. The initiation of a clutch operation requires energy which has to be available at the time of the clutch actuation in order to be able to provide a clutch actuation force which carries out the clutch operation.

It is known, for clutch actuation, to use electric motors, electromechanical or electromagnetically actuated actuators or hydraulic pumps and hydraulically actuated actuators which actuate the clutch mechanism or apply the clutch actuation force required for the clutch operation.

Electric motors or electrically actuated actuators and where applicable the cable harnesses required for the supply and control thereof and control devices have a relatively great weight, take up a lot of structural space and may—in particular when they draw high currents—lead to electromagnetically induced malfunctions.

Hydraulic pumps have to be driven in order to produce the hydraulic pressure required for the clutch operation and thus cause power loss.

### SUMMARY

The present disclosure relates to a system for actuating a clutch apparatus of a device for power transmission and/or power distribution of the drive power of a motor vehicle, in particular a motor car or passenger vehicle, wherein the device for power transmission and/or power distribution
has primary drive members which during correct installation and use of the device for power transmission and/or power distribution are permanently driven or towed on the motor vehicle during travel, and
has secondary drive members which, during correct installation and use of the device for power transmission and/or power distribution on the motor vehicle if required can be coupled to the primary drive members or can be decoupled from the primary drive members by means of a clutch apparatus,
   and wherein the clutch apparatus comprises a clutch actuation device having a disengagement unit for decoupling primary and secondary drive members.

Further disclosed is a device for power transmission and/or power distribution of the drive power of a motor vehicle having such a system for actuating a clutch apparatus and a motor vehicle having a drive train which comprises such a device.

Provide is a system for actuating a clutch apparatus which requires a low energy consumption, in particular a lower current strength than electric motors or electric actuators. Furthermore, the clutch actuation device can have a low risk of electromagnetic interferences, a low weight and a low structural spatial requirement. It can be capable of actuating the clutch spontaneously and with a low response time which is independent of the vehicle speed and which provides a high clutch actuation force. The design is intended to be such that it can be used for a large number of different clutch variants.

To this end, provision is made inter alia for the disengagement unit, in order to provide the clutch actuation force required to actuate the clutch apparatus, to be operationally connected to the secondary drive members. Alternatively or additionally, there may be provision for a drive clutch to be provided which, in order to provide the clutch actuation force required to actuate the clutch apparatus, is capable of producing an operational connection between the primary drive members or the secondary drive members, on the one hand, and the disengagement unit, on the other hand.

In both the above-mentioned cases, it is ensured that the disengagement unit, which may in particular comprise a hydraulic pump which is intended to be driven for the clutch operation, brings about no permanent power loss when the secondary drive members are decoupled from the primary axle and the secondary drive wheels and stop in accordance with provisions described herein.

If the disengagement unit is operationally connected to the secondary drive members and the secondary drive members are stopped in 2-WD mode, the disengagement unit in order to produce a clutch actuation force cannot tap any power from the stopped secondary drive members. The components of the disengagement unit, for instance, the hydraulic pump which has already been mentioned, do not run but are instead also stopped and cause no power loss at all.

When a drive clutch is used to produce an operational connection between secondary or primary drive members, on the one hand, and the disengagement unit, on the other hand, the clutch actuation device or the components thereof are also stopped and cause no power loss. In the event that the drive clutch is arranged between primary drive members which rotate permanently during travel and the clutch actuation device, this of course only applies with an open drive clutch. With a drive clutch which is arranged between secondary drive members and the disengagement unit, there is the additional advantage that the clutch actuation device itself in 4-WD mode, and in spite of co-rotating secondary drive members, does not cause any power loss as long as the drive clutch is not controlled and consequently transmits no torque.

The clutch apparatus for coupling or decoupling from the primary and secondary drive members can be a clutch which functions in a positive-locking manner (also referred to as a dog clutch), in particular a claw clutch or a clutch having a sliding sleeve which connects the primary and secondary drive members in a positive-locking manner and which can be moved back and forth between a connect position, in which the primary and secondary drive members are connected to each other in a positive-locking manner, and a disconnect position, in which the primary and secondary drive members are separated from each other.

The drive clutch can be a drive clutch which can be switched on demand. In order to ensure that the drive clutch itself causes no or only negligible power loss, a clutch which operates in a contactless manner may in particular be provided. This may be a magnetic clutch which operates in a contactless manner. Another example of such a drive clutch is an eddy current clutch.

The use of such a clutch which operates in a contactless manner and which can preferably be controlled electrically can also be considered to be particularly advantageous since the torque transmission potential which is ensured by such a clutch is limited. Such a drive clutch may thus, for example, when a hydraulic pump is used to provide a hydraulic pressure which ensures the clutch actuation force, be effectively used as a pressure limiter or overload protection member. Furthermore, such a clutch enables effective pressure limitation in both travel directions or rotation directions of the clutch members.

In addition, the torque transmission potential of such a drive clutch is dependent on the power supply of the clutch and can consequently be adjusted in a selective manner by means of a selective application of current. As a result of the adjustment of the torque transmission potential via the current which is supplied to the clutch, the torque which can be transmitted to the disengagement unit, and which determines the level of the clutch actuation force, can consequently not only be effectively limited, but instead can also be selectively adjusted when necessary. The clutch actuation force and the speed of the pressure build-up and consequently also the speed of the engagement or disengagement operation can also be influenced in a selective manner. A seamless, smooth coupling and decoupling are also possible.

For the engagement operation, the clutch actuation device can also have, in addition to the disengagement unit, an engagement unit. The engagement unit ensures the engagement of the clutch apparatus and consequently the connection of the portion of the secondary drive train which is stopped in 2-WD or disconnect mode with respect to the primary axle and the components which are towed by the secondary drive wheels with respect to the primary drive members.

The engagement unit can have a pretensioning element which stores potential energy for the engagement operation. This ensures that the clutch force required for the engagement operation is continuously kept ready. A resilient element may in particular be considered as a pretensioning element.

In order also to keep the pretensioning element in particular under tension (in a position which keeps the potential energy ready) when the clutch apparatus is not operationally connected to a rotating portion of the drive train and therefore cannot generate any new clutch actuation force, the disengagement unit may have a retention element which holds the clutch by means of a retention force during operation of the vehicle in 2-WD mode in a disconnect position.

In this case, the retention element can be constructed in such a manner that it is capable of keeping the clutch apparatus, during operation of the vehicle in 2-WD mode without constant energy supply and consequently in a permanently power-loss-free manner, in the disconnect position, and it has to be actively controlled, for example, provided with current or activated in another manner, when it is intended to release the energy stored in the pretensioning element in order to initiate the engagement operation by applying the retention force. Energy is therefore only required for the actual clutch operation, that is to say, the engagement or disengagement, but not for retaining the clutch state in the connect or disconnect mode. It is possible to consider in particular an electrically controllable magnetic retention member with a permanent magnet as a retention device.

The embodiment of the engagement unit described above additionally ensures the initiation and the implementation of the engagement operation independently of the available “energy density” of the current travel state, that is to say, in particular independently of the vehicle speed since the potential energy which is kept ready by the pretensioning element is constant independently of the travel state. The driver therefore always perceives the engagement operation independently of the travel state as being carried out at the same speed, regardless of how quickly he is currently driving.

The above embodiment further ensures that the system for actuating a clutch apparatus can be constructed in a bi-stable manner. This means that energy does not have to be applied either for permanently maintaining the 2-WD or disconnect mode or for permanently maintaining the 4-WD or connect mode, but instead the respective states are kept in a state free of energy supply. Only for initiating and carrying out an engagement or disengagement operation is the provision of energy to produce a clutch actuation force required.

It should be noted that the engagement unit and the disengagement unit do not have to be devices which are completely separated from each other. Instead, both units may also share components and the functions thereof.

Other features and advantages will be appreciated from the dependent claims and the following description of example embodiments with reference to the drawings.

### SUMMARY OF THE DRAWINGS

In the drawings:

FIG. 1 is a schematic illustration of an entire drive train of a motor vehicle according to the prior art with a permanently driven primary drive train and with a secondary drive train which can if necessary be connected to the primary drive train or be decoupled therefrom,

FIG. 2 shows a PTU (Power Takeoff Unit) according to the prior art and how it can be used in the drive train shown in FIG. 1,

FIG. 3 shows an RDU (Rear Drive Unit) according to the prior art and how it can be used in the drive train shown in FIG. 1,

FIG. 4 is a schematic illustration of a bi-stable clutch actuation device with a disengagement unit and an engagement unit and a drive clutch which operates between a primary or secondary drive member and a manipulated variable unit,

FIG. 5 is a schematic illustration of a modification of the embodiment shown in FIG. 4 with a direct connection between the secondary drive member and the manipulated variable unit and with an additional pressure limitation valve,

FIG. 6 is a schematic illustration of a bi-stable clutch actuation device with a dual-action clutch actuator and a bi-stable retention element and a drive clutch which operates between a primary or secondary drive member and a manipulated variable unit, and

FIG. 7 is a schematic illustration of a modification of the embodiment shown in FIG. 6 with a direct connection between the secondary drive member and the manipulated variable unit and with an additional pressure limitation valve.

### DESCRIPTION

FIG. 1 shows a drive train construction known from the prior art with a permanently driven primary drive train—in FIG. 1 by way of example the portion of the overall drive train which is permanently driven by a front engine and which directs the drive power to the front wheels—and a secondary drive train which is driven only as required and via which the drive power is also directed as necessary to the secondary drive wheels. Of course, other drive train configurations, in which the primarily driven axle is, for example, the rear axle and/or in which a rear or central motor is used, are also conceivable.

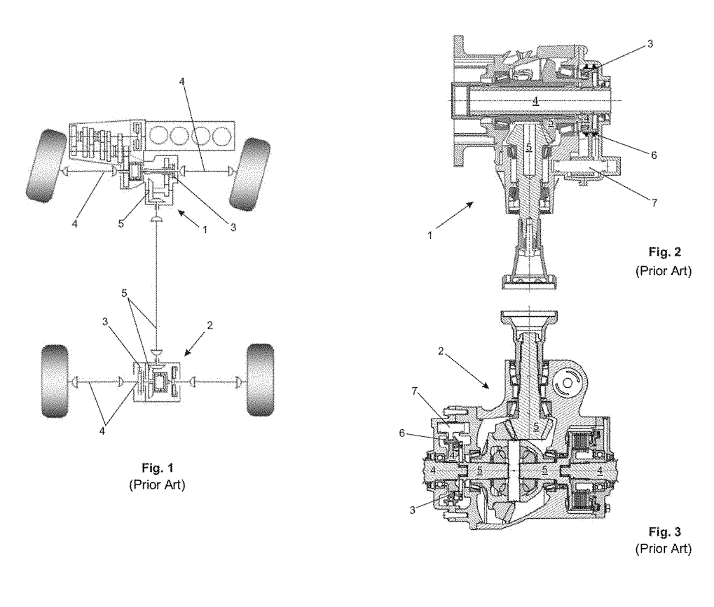

In 4WD mode or Connect mode, via a PTU 1 which is shown in detail in FIG. 2, drive power is tapped at the primary drive train and directed via a cardan shaft to an RDU 2 which is shown in detail in FIG. 3 and which takes up the function of transverse compensation and transmits the drive power to both secondary drive wheels. PTU and RDU each constitute a device for power transmission and/or power distribution of the drive power in the context of this disclosure.

Both on the PTU 1 and on the RDU 2, there is provided a clutch apparatus 3 which acts in a positive-locking manner and by means of which the primary drive members 4 and secondary drive members 5 of the PTU or the RDU can be coupled to each other or decoupled from each other. To this end, a hydraulic actuation 7 displaces as a portion of a disengagement unit of the clutch actuation device a sliding sleeve 6 between a connect position (primary and secondary drive members are coupled to each other) and a disconnect position (primary and secondary drive members are decoupled from each other).

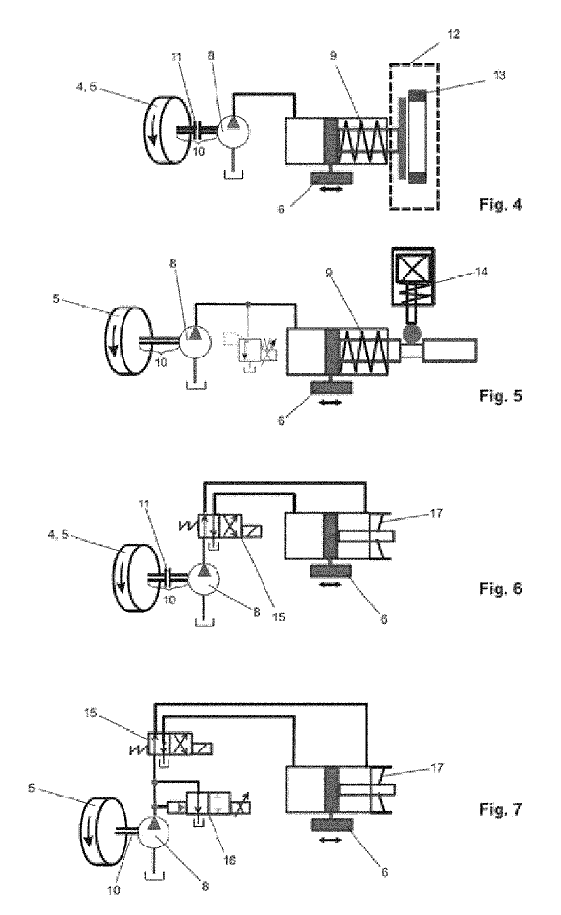

FIGS. 4 to 7 are schematic illustrations of a clutch actuation device according to example embodiments, as can be used in a drive train or one of the devices for power transmission and/or power distribution of the drive power as shown in FIG. 2 or FIG. 3. The sliding sleeve 6 shown in FIGS. 4 to 7 corresponds in terms of its function to the sliding sleeve 6 shown in FIG. 2 and FIG. 3 and can be displaced by means of a hydraulic actuation 7 from a connect position into a disconnect position (indicated by the double-headed arrow below the sliding sleeve 7). Non-hydraulically acting actuators can also be used.

The hydraulic actuation 7 is provided with a hydraulic pressure produced by a hydraulic pump 8 in order to displace the sliding sleeve 6 counter to the force of a spring 9 which acts as a pretensioning element from a connect position into a disconnect position and thus to complete a disengagement operation of the clutch. The hydraulic pump 8 represents as a component of a disengagement unit a manipulated variable unit which provides a manipulated variable (in this instance: hydraulic pressure) which is used to produce a clutch disengagement force. Of course, the use of other types of different manipulated variable units which provide different types of manipulated variables is also conceivable in principle. In particular, in place of a hydraulic pump which is driven by a drive clutch, an electromagnetic clutch which drives a ramp mechanism may be provided.

The hydraulic pump 8 (the manipulated variable unit of the clutch apparatus) is operationally connected by an operational connection 10 and an interposed drive clutch 11 to a secondary drive member 5 so as to transmit power. The secondary drive member, with which the manipulated variable unit is operationally connected, may be formed by any desired drive member of the portion of the secondary drive train which is stopped in 2-WD mode and which rotates in 4-WD mode, for example, from the cardan shaft or an input or output shaft of the device for power transmission and/or power distribution of the drive power.

The drive clutch 11 is preferably a magnetic or eddy current clutch which operates in a contactless manner, which can be switched on demand and which can be controlled in an electrical manner. The use of such a clutch which limits the torque which can be transmitted has the advantage that—as a result of the contactless running and the torque which can be transmitted only in a limited manner—it also acts as a pressure limiter because the pressure produced by the hydraulic pump is directly dependent on the torque transmitted to the hydraulic pump. Consequently, when such a drive clutch 11 is used, the pressure limitation valve can be dispensed with. The clutch only has to be configured with respect to the torque transmission potential thereof in such a manner that the hydraulic pressure produced is sufficient to force the sliding sleeve during a disconnect operation into the disconnect position. Furthermore, the power which is intended to be transmitted via the drive clutch to the hydraulic pump can be varied by means of corresponding control of the pump and where necessary can be reduced to zero.

The described arrangement enables—apart from the respective switching operations—operation both in 4-WD mode or connect mode and in 2-WD or disconnect mode without significant towing losses and without consuming electrical energy.

Whilst the components and operations described above with respect to FIG. 4 relate to the disengagement unit or the function thereof for the disconnect operation, the engagement operation or the components and operations which relate to the engagement operation are described below.

The spring 9 which acts as a pretensioning element stores a large portion of the energy which is introduced into the system during the disengagement operation in order to produce the clutch operation. The resilient force urges or biases the sliding sleeve 6 from the disconnect position back into the connect position but it is retained in the disconnect position by means of a magnetic retention member 12 which acts as a retention element during operation in 2-WD mode. The magnetic retention member 12 is sized in such a manner that the retention force thereof is greater than the resilient force of the pretensioning element which acts in the opposing direction.

The magnetic retention member 12 is electrically switchable and has a permanent magnet 13 to which current can be applied. In order to initiate the connect operation, the permanent magnet is electrically controlled, whereby it loses its magnetic force. The retention force is thus cancelled or reduced and the magnetic switch releases the restoring force of the pretensioning element 9 in order to initiate the connect operation. In the connect mode, there is an air gap (gap width, for example, >2 mm) between the permanent magnet 13 and the component of the magnetic retention member 12 keeping it in the disconnect mode so that, even when the current supply is switched off, the permanent magnet is not “pulled” back into the disconnect position.

A retention device which is provided with such a magnetic retention member enables a high restoring force (F >1000 Newtons (N)) at low current strengths (I<2 Amps (A)), wherein, according to current requirements, it should be assumed that the magnetic retention member only has to be capable of securely maintaining a resilient force of the pretensioning element greater than 300 N. In addition, such a magnetic retention member has only a small structural spatial requirement.

It should be mentioned that, when the drive clutch 11 which is shown in FIG. 4 and which operates in a base-loss-free manner is used, a power transmitting operational connection of the disengagement unit with the primary drive members 4 is also possible because in this instance, any towing losses are also prevented.

FIG. 5 shows a slight modification of the embodiment which is shown in FIG. 4 and in which the drive clutch which—as described above—also performs the function of a pressure limiter, is dispensed with. Consequently, a portion of the disengagement unit is also a pressure limitation valve 16 which allows the pressure which is produced by the hydraulic pump 8 not to exceed an appropriate maximum value. In order to keep the power loss as low as possible in connect mode, the pressure limiter in this travel mode can be adjusted to low pressure, e.g., to zero.

Furthermore, FIG. 5 shows an alternative embodiment of a retention element in the form of a switching detent 14 in which an electromagnetically actuated locking detent engages in a catch groove and is thus capable of holding the sliding sleeve in an energy-supply-free manner in the disconnect position. Also in this instance, there is provision for the switching detent 14 to have to be controlled in order to release the pretensioning force applied by the pretensioning element 9 for the engagement operation.

Of course, the switching detent 14 may also be used in the embodiment shown in FIG. 4 in place of the magnetic switch 12 which is illustrated therein and vice versa.

FIG. 6 shows a variant in which a pretensioning element 9 which stores potential energy, as shown in FIG. 4 and FIG. 5, is dispensed with. Instead, a bi-stable retention element 17 in the manner of a plate spring is used. Such a retention element can be moved starting from a first position which is stable per se into a second position which is stable per se if it is urged counter to an inner resistance beyond an indifferently stable zero position. Consequently, when such a retention element is used, a generally bi-stable clutch apparatus is also ensured and, neither during operation of the motor vehicle in 2-WD mode nor during operation thereof in 4-WD mode, requires an energy supply in order to maintain the respective clutch state. This is required only for the actual clutch operation.

In order to control a hydraulic actuation there is again provided a hydraulic pump 8 which can be operationally connected, via an interposed drive clutch 11 which limits the torque which can be transmitted, to a secondary drive member 5 (where applicable also to a primary drive member 4) so as to transmit power. The hydraulic pump 8 controls in the example shown in FIG. 6 a dual-action hydraulic actuation and has a control valve 15 which is required for this purpose.

FIG. 7 finally shows an embodiment of a system for controlling a clutch apparatus in which, in comparison with the embodiment shown in FIG. 6, a drive clutch 11 by means of which the torque which can be transmitted to the hydraulic pump 8 can also be limited is dispensed with. Also in this instance, there is therefore provided a pressure limitation valve which does not allow the pressure produced by the hydraulic pump 8 to exceed a suitable maximum value.

When the clutch actuation device is constructed in such a manner that the disengagement unit for the provision of the clutch actuation force which is required for the actuation of the clutch apparatus is operationally connected to the secondary drive members—regardless of whether this takes place via a drive clutch 11 (FIG. 4 and FIG. 6) or without such a drive clutch (FIG. 5 and FIG. 7)—there may further be provision for the drive torque which is tapped via the operational connection from the secondary members in order to provide the manipulated variable for the clutch actuation force to be used, after the disengagement operation as a brake torque for the secondary drive members. In particular, by adjusting a high manipulated variable (for instance, a high hydraulic pressure) there can be requested a high drive torque which, after completing the disengagement operation, acts as a brake torque. It is thus possible to prevent even for a slowed further rotation of the secondary drive members which may occur, for example, as a result of hydrodynamic effects, in multiple-disc clutches, a disconnect mode.

The use of an electrically controllable magnetic switch as a retention element and component of a clutch actuation device, in particular as a component of an engagement unit of a clutch actuation device, is, separately from the features of the above-described disengagement unit, is considered to be part of this disclosure.

### LIST OF REFERENCE NUMERALS

1 Power Takeoff Unit (PTU)

2 Rear Drive Unit (RDU)

3 Clutch apparatus

4 Primary drive members

5 Secondary drive members

6 Sliding sleeve (engagement member)

7 Hydraulic actuation

8 Manipulated variable unit (hydraulic pump)

9 Pretensioning element (resilient element)

10 Operational connection

11 Drive clutch

12 Retention element (magnetic retention member)

13 Permanent magnet

14 Retention element (switching detent)

15 Control valve

16 Pressure limitation valve

17 Bi-stable retention element

1.-14 (canceled)

15. A system for actuating a clutch apparatus of a power transmission/distribution device for at least one of power transmission and power distribution of the drive power of a motor vehicle that has a permanently driven primary drive train and a secondary drive train which can be connected to the primary drive train, the system comprising
the power transmission/distribution device, including
primary drive members which during correct installation of the power transmission/distribution device are permanently driven or towed on the motor vehicle during travel, and
secondary drive members which, during correct installation of the power transmission/distribution device on the motor vehicle are couplable to, and decouplable from, the primary drive members by the clutch apparatus;
wherein the clutch apparatus has a clutch actuation device having a disengagement unit for decoupling primary drive members and secondary drive members;
wherein the disengagement unit for the provision of clutch actuation force to actuate of the clutch apparatus is operationally connected to the secondary drive members.

16. The system as claimed in claim 15, wherein there is provided a drive clutch which in order to provide the clutch actuation force is arranged to produce an operational connection between the primary drive members or the secondary drive members and a manipulated variable unit of the disengagement unit.

17. The system as claimed in claim 15, wherein the clutch apparatus is a clutch which acts in a positive-locking manner.

18. The system as claimed in claim 16, wherein the drive clutch is a clutch which can be switched on demand and which can be controlled electrically.

19. The system as claimed in claim 16, wherein the drive clutch is a clutch which operates in a contactless manner.

20. The system as claimed in claim 16, wherein the drive clutch is a magnetic clutch or an eddy current clutch.

21. The system as claimed in claim 16, wherein the drive clutch acts as a pressure limitation device for a manipulated variable unit which produces hydraulic pressure.

22. The system as claimed in claim 15, further comprising an engagement unit that has a pretensioning element which stores potential energy for the engagement operation.

23. The system as claimed in claim 15, wherein the clutch apparatus comprises a retention element which is arranged for retaining an engagement member which produces the positive-locking connection of the clutch in a permanently disengaged position.

24. The system as claimed in claim 15, wherein the clutch apparatus is a bi-stable clutch apparatus.

25. The system as claimed in claim 23, wherein the retention element is formed by an electrically controllable magnetic retention member or an electrically controllable switching detent.

26. The system as claimed in claim 15, wherein the retention element is configured such that, during operation of the motor vehicle with the clutch disengaged or engaged, the respective switching state of the clutch apparatus can be kept permanently in an energy-supply-free state.

27. The system as claimed in claim 23, further comprising a bi-stable retention element which, starting from a first position which is stable per se, can be moved into a second position which is stable per se if it is urged counter to an internal resistance beyond an indifferently stable zero position.
